(19) United States
(12) Patent Application Publication
(10) Pub. No.: US 2017/0228850 A1
(43) Pub. Date: Aug. 10, 2017

(54) GRAPHICS-PROCESSING-UNIT SHADER PROGRAM CONTROL FLOW EMULATION

(71) Applicant: Microsoft Technology Licensing, LLC, Redmond, WA (US)

(72) Inventor: Matthew Gordon, Kirkland, WA (US)

(21) Appl. No.: 15/018,773

(22) Filed: Feb. 8, 2016

(51) Int. Cl. G06T 1/20; G06T 15/80

(52) U.S. Cl. CPC G06T 1/20; G06T 15/80

(57) ABSTRACT

The control flow of a first graphics-processing-unit shader program coded in a low-level programming language that allows arbitrary jumps is emulated in a second graphics-processing-unit shader program coded in a higher-level programming language that does not allow arbitrary jumps. Each instruction in the first program is individually evaluated as follows. First it is determined if the instruction is the first instruction in the first program or a jump destination therein. Whenever it is determined that the instruction is the first instruction in the first program or a jump destination therein, an appropriate case label is inserted into the second program. Then it is determined if the instruction is a jump instruction. Whenever it is determined that the instruction is a jump instruction, the jump instruction is translated into an appropriate switch case statement in the higher-level language, and this switch case statement is inserted into the second program.

### BACKGROUND

A graphics-processing-unit (GPU) is a specialized programmable electronic circuit that efficiently and rapidly renders images, animations and video for display on the display screen of a computing device. For example, GPUs create lighting effects and transform objects every time a scene in a given application is redrawn. Today's GPUs have a massively parallel architecture that includes a large number (e.g., thousands) of small, specialized processing cores designed for handling a plurality of tasks at the same time (e.g., in parallel). Although GPUs are useful for rendering two-dimensional (2D) data as well as for zooming and panning the screen, GPUs are essential for smooth decoding and rendering of three-dimensional (3D) animations and video. In addition to being used for computer graphics applications, GPUs are increasingly being used as vector processors for non-graphics applications that require repetitive computations.

In the art of computer graphics a shader is a computer program that is executed on a GPU and is used to calculate customized rendering effects with a high degree of flexibility. Accordingly, shaders are herein sometimes referred to as GPU shader programs for clarity. GPU shader programs are commonly coded in a specific language for a specific GPU or target environment. GPU shader programs can alter various attributes of individual pixels in an image, or of vertices or textures used to construct an image, on the fly. GPU shader programs are commonly used in a variety of applications such as computer-generated imagery, video games, and video/cinema post-processing. GPU shader programs can produce a wide range of different rendering effects ranging from simple lighting models to more complex effects such as altering the hue, saturation, brightness and contrast of an image, and producing blur, light bloom, volumetric lighting, and normal mapping for depth effects, among many others. An exemplary type of 2D GPU shader program is the pixel shader program that modifies the attributes of pixels in a given 2D image. Various types of 3D GPU shader programs also exist that modify the attributes of a given 3D model representing a given object. Exemplary types of 3D GPU shader programs include a vertex shader program, a geometry shader program, and a tessellation shader program.

### SUMMARY

Control flow emulation technique implementations described herein generally involve emulating the control flow of a first graphics-processing-unit (GPU) shader program in a second GPU shader program, where the first GPU shader program includes a sequence of instructions and is coded in a low-level programming language that allows arbitrary jumps, and the second GPU shader program is coded in a higher-level programming language that does not allow arbitrary jumps. In one exemplary implementation each of the instructions in the sequence of instructions is individually evaluated in the following manner. First it is determined if the instruction is the first instruction in the first GPU shader program or a jump destination therein. Whenever it is determined that the instruction is the first instruction in the first GPU shader program or a jump destination therein, an appropriate case label is inserted into the second GPU shader program. Then it is determined if the instruction is a jump instruction. Whenever it is determined that the instruction is a jump instruction, the jump instruction is translated into an appropriate switch case statement in the higher-level programming language, and this switch case statement is inserted into the second GPU shader program.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the control flow emulation technique implementations described herein will become better understood with regard to the following description, appended claims, and accompanying drawings where:

FIG. 1 is flow diagram illustrating an exemplary implementation, in simplified form, of a process for emulating the control flow of a first graphics-processing-unit (GPU) shader program in a second GPU shader program, where the first GPU shader program is coded in a low-level programming language that allows arbitrary jumps and the second GPU shader program is coded in a higher-level programming language that does not allow arbitrary jumps.

FIG. 2 is a program listing illustrating one implementation, in simplified form, of the first GPU shader program that includes an unconditional jump instruction.

FIG. 3 is a program listing illustrating an exemplary implementation, in simplified form, of pseudo code for the second GPU shader program that is generated by using the emulation process of FIG. 1 to emulate the control flow the first GPU shader program shown in FIG. 2.

FIG. 4 is a program listing illustrating another implementation, in simplified form, of the first GPU shader program that includes both a conditional jump instruction and an unconditional jump instruction.

FIG. 5 is a program listing illustrating an exemplary implementation, in simplified form, of pseudo code for the second GPU shader program that is generated by using the emulation process of FIG. 1 to emulate the control flow the first GPU shader program shown in FIG. 4.

FIG. 6 is a diagram illustrating an exemplary implementation, in simplified form, of a shader program translator computer program for emulating the control flow of the first GPU shader program in the second GPU shader program.

FIG. 7 is a diagram illustrating a simplified example of a general-purpose computer system on which various implementations and elements of the control flow emulation technique, as described herein, may be realized.

### DETAILED DESCRIPTION

In the following description of control flow emulation technique implementations reference is made to the accompanying drawings which form a part hereof, and in which are shown, by way of illustration, specific implementations in which the control flow emulation technique can be practiced. It is understood that other implementations can be utilized and structural changes can be made without departing from the scope of the control flow emulation technique implementations.

It is also noted that for the sake of clarity specific terminology will be resorted to in describing the control flow emulation technique implementations described herein and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation”, or “one version”, or “another version”, or an “exemplary version”, or an “alternate version” means that a particular feature, a particular structure, or particular characteristics described in connection with the implementation or version can be included in at least one implementation of the control flow emulation technique. The appearances of the phrases “in one implementation”, “in another implementation”, “in an exemplary implementation”, “in an alternate implementation”, “in one version”, “in another version”, “in an exemplary version”, and “in an alternate version” in various places in the specification are not necessarily all referring to the same implementation or version, nor are separate or alternative implementations/versions mutually exclusive of other implementations/versions. Yet furthermore, the order of process flow representing one or more implementations or versions of the control flow emulation technique does not inherently indicate any particular order nor imply any limitations of the control flow emulation technique.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive, in a manner similar to the term “comprising”, as an open transition word without precluding any additional or other elements.

### 1.0 Graphics-Processing-Unit (GPU) Shader Program Control Flow Emulation

The term “instruction” is used herein to refer to a line of code in a computer program that is coded in a given low-level imperative programming language—this definition of the term “instruction” is generally consistent with its use in the art of computer programming. The term “statement” is used herein to refer to a line of code in a computer program that is coded in a given higher-level imperative programming language—this definition of the term “statement” is generally consistent with its use in the art of computer programming. As is appreciated in the art of computer programming, the statements of a computer program are complied into a set of machine code instructions for a target processing unit, where a given statement may represent a plurality of machine code instructions.

Generally speaking and as is also appreciated in the art of computer programming, an assembly language is a low-level imperative programming language for a target computer processing unit (e.g., a graphics-processing-unit (GPU), among other types of computer processing units) in which there is a strong (generally a one-to-one) correspondence between the language and the machine code instructions of the processing unit. As such, each different assembly language is generally specific to a particular computer processing unit. In contrast, a higher-level programming language may generally be compiled to operate on a plurality of different computer processing units (in other words, higher-level programming languages are generally portable across different computer processing units).

As is appreciated in the art of computer graphics and described heretofore, a shader is a computer program that is executed on a GPU and is used to calculate customized rendering effects with a high degree of flexibility. Accordingly, shaders are hereafter referred to as either GPU shader programs or simply shader programs for clarity. GPU shader programs are commonly coded in a specific language for a specific GPU or target environment. The language in which a given shader program is coded depends on the target environment for the program. By way of example but not limitation, shader programs targeted for the older DIRECT3D® (a registered trademark of Microsoft Corporation) 8 and 9 graphics application programming interfaces (APIs) are coded using a conventional low-level assembly language (sometimes referred to as the shader assembly language). Shader programs targeted for newer graphics APIs are generally coded using a higher-level programming language. By way of example but not limitation, shader programs targeted for the DIRECT3D® (a registered trademark of Microsoft Corporation) 9 graphics API may also be coded using the conventional High-Level Shader Language (HLSL). Shader programs targeted for the DIRECT3D® (a registered trademark of Microsoft Corporation) 10 and higher graphics APIs (where low-level assembly language coding is deprecated) are coded using HLSL. Shader programs targeted for the Open Graphics Library (OPENGL® (a registered trademark of Silicon Graphics, Inc)) and the OPENGL® (a registered trademark of Silicon Graphics, Inc) for Embedded Systems (OPENGL ES or GLES) graphics APIs are coded using the conventional OPENGL® (a registered trademark of Silicon Graphics, Inc) Shading Language (GLSL).

As is also appreciated in the art of computer programming, the term “control flow” (or alternatively, flow of control) refers to the order in which individual instructions or statements of an imperative computer program are executed. GPU shader programs are imperative computer programs since the aforementioned different types of languages in which GPU shader programs are coded (e.g., assembly language, HLSL and GLSL) are imperative programming languages. Within an imperative programming language, a control flow instruction/statement is an instruction/statement whose execution results in a choice being made as to which of two or more paths in a computer program should be followed. Different imperative programming languages generally support different types of control flow instructions. These different types of control flow instructions can generally be categorized by their effect as follows. One type of control flow instruction/statement redirects the execution to a distant instruction/statement that is not the next instruction/statement in the program; an unconditional jump (also known as an unconditional branch) is an example of this type of control flow instruction/statement. Another type of control flow instruction/statement executes a set of instructions/statements, which may not be the next instructions/statements in the program, just when a specified condition is met; a conditional jump (also known as a conditional branch) is an example of this type of control flow instruction/statement. Another type of control flow instruction/statement executes a set of instructions/statements zero or more times until a specified condition is met; this type of control flow instruction/statement is sometimes referred to as a loop. Another type of control flow instruction/statement executes a set of distant instructions/statements and then generally returns the flow of control to the next instruction/statement in the program after the control flow instruction/statement; subroutine and coroutine calls are examples of this type of control flow statement.

The control flow emulation technique implementations described herein generally involve emulating the control flow of a first GPU shader program in a second GPU shader program, where the first GPU shader program is coded in a low-level programming language that allows arbitrary jumps and the second GPU shader program is coded in a higher-level programming language that does not allow arbitrary jumps. As is appreciated in the art of computer programming, arbitrary jumps in a given computer program (e.g., a “jump” to a destination “label” which can be any address in the program relative to the origin “jump”) enable arbitrary control flows in the program. This ability to perform arbitrary jumps is the most common way of expressing control flow in low-level programming languages. The ability to perform arbitrary jumps in a higher-level programming language is sometimes referred to as the “goto” feature. Various types of conventional low-level programming languages (such as the aforementioned conventional shader assembly language, among others) allow arbitrary jumps. While some types of higher-level programming languages (such as C and C++, among others) allow arbitrary jumps, other types of higher-level programming languages (such as the aforementioned conventional HLSL and GLSL) do not allow arbitrary jumps. As described heretofore, various types of GPU shader programs exist that can produce a wide range of different rendering effects. The control flow emulation technique described herein can be used to emulate the control flow any type of GPU shader program including, but not limited to, the aforementioned pixel shader program, or vertex shader program, or geometry shader program, or tessellation shader program.

The control flow emulation technique implementations described herein are advantageous for various reasons including, but not limited to, the following. As will be appreciated from the more-detailed description that follows, the control flow emulation technique implementations can accurately translate the control flow of the first GPU shader program into the higher-level programming language of the second GPU shader program regardless of the complexity of the first GPU shader program's jump graph. The term “jump graph” is used herein to refer to a tree-style graph that represents all of the possible paths (e.g., control flows) that can be taken through a given computer program by following all of the different jump instructions or statements in the program. As such, a jump graph is sometimes also referred to as a control flow graph in the art of computer programming. The control flow emulation technique implementations explicitly preserve all of the possible control flows that may exist in the first GPU shader program that is being emulated, including those control flows that are semantically critical to the operation of the program. As such, the control flow emulation technique implementations support arbitrarily complicated jump graphs. The control flow emulation technique implementations also enable backward compatibility between older graphics software applications (such as video game applications that were developed for the XBOX 360® (a registered trademark of Microsoft Corporation) video game console) and newer graphics processing hardware (such as the GPU utilized in the XBOX ONE™ (a trademark of Microsoft Corporation) video game console).

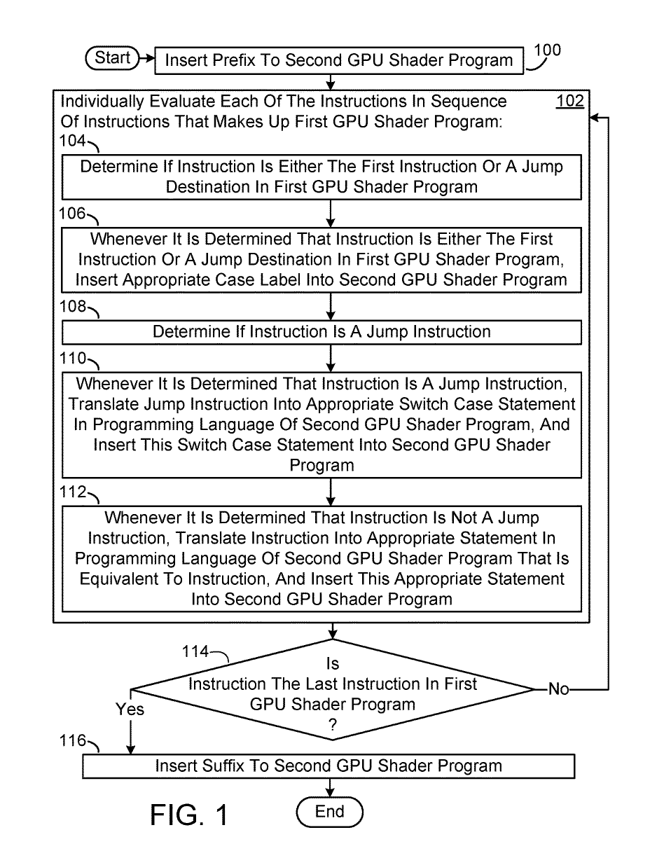

FIG. 1 illustrates an exemplary implementation, in simplified form, of a process for emulating the control flow of the just-described first GPU shader program in a second GPU shader program, where the first GPU shader program is coded in a low-level programming language that allows arbitrary jumps and the second GPU shader program is coded in a higher-level programming language that does not allow arbitrary jumps. As exemplified in FIG. 1, the emulation process starts with inserting a prefix to the second GPU shader program (process action 100), where this prefix serves to manage the control flow through the program. After the prefix to the second GPU shader program has been inserted (action 100), each of the instructions in the sequence of instructions that makes up the first GPU shader program is individually evaluated (process action 102). In other words, each instruction in the first GPU shader program is sequentially (e.g., in order) evaluated on a stand-alone basis without “walking” the program's jump graph.

Referring again to FIG. 1, in an exemplary implementation of the control flow emulation technique described herein the just-described individual evaluation of each instruction in the first GPU shader program (action 102) is realized as follows. First, it is determined if the instruction is either the first instruction in the first GPU shader program or a jump destination therein (process action 104). The term “jump destination” is used herein to refer to any instruction in a computer program that is jumped to by another instruction in the program (e.g., a jump destination is the destination for a jump instruction elsewhere in the program). It will be appreciated that the first instruction in a computer program is, by its nature, herein always considered to be a jump destination. It will further be appreciated that the instruction immediately after a conditional jump instruction in a computer program is also, by its nature, herein always considered to be a jump destination since, in the case where the condition specified in the conditional jump instruction is not met, the program will jump to the instruction that immediately follows the conditional jump instruction. Whenever it is determined that the instruction is the first instruction in the first GPU shader program or a jump destination therein, an appropriate case label is inserted into the second GPU shader program (process action 106). It is then determined if the instruction is a jump instruction (process action 108). Whenever it is determined that the instruction is a jump instruction, the jump instruction is translated into an appropriate switch case statement in the higher-level programming language of the second GPU shader program, and this switch case statement is inserted into the second GPU shader program (process action 110). Whenever it is determined that the instruction is not a jump instruction, the instruction is translated into an appropriate statement in the higher-level programming language of the second GPU shader program that is equivalent to the instruction, and this appropriate statement is inserted into the second GPU shader program (process action 112). Then, whenever the instruction is not the last instruction in the first GPU shader program (process action 114, No), action 102 is repeated for the next instruction in the first GPU shader program. Whenever the instruction is the last instruction in the first GPU shader program (process action 114, Yes), a suffix to the second GPU shader program is inserted (process action 116), where this suffix serves to close the program.

Referring again to FIG. 1, it is noted that the just-described action of translating a jump instruction into an appropriate switch case statement in the higher-level programming language of the second GPU shader program (action 110) will be realized differently depending on whether the jump instruction is an unconditional jump instruction or a conditional jump instruction. More particularly and by way of example but not limitation, whenever the jump instruction is an unconditional jump instruction its translation will be realized as follows. The destination of the unconditional jump instruction is decoded, and then a label is set based on this decoding. Whenever the jump instruction is a conditional jump instruction that specifies a condition which has to be met in order for the jump to be executed, its translation will be realized as follows. The destination of the conditional jump instruction is decoded, then the condition specified in the conditional jump instruction is decoded, then an appropriate statement in the higher-level programming language is generated that evaluates (e.g., tests) this condition, and then a label is set based on the outcome of evaluating the condition.

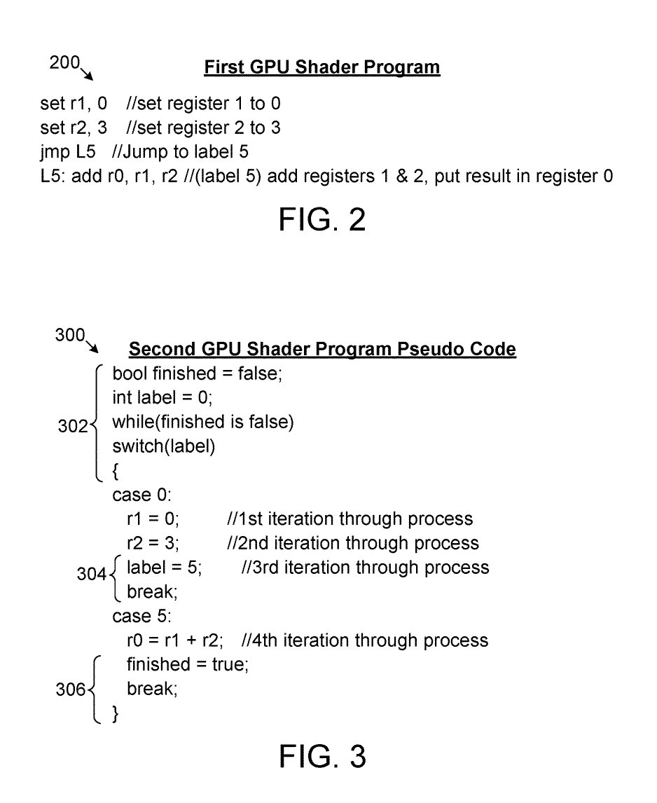

FIG. 2 is a program listing illustrating one implementation, in simplified form, of the first GPU shader program that includes an unconditional jump instruction. As exemplified in FIG. 2, the first GPU shader program 200 includes a sequence of four instructions and is coded in a low-level programming language that allows arbitrary jumps. More particularly, one of the instructions in the program 200 (the “jmp L5” instruction) is an unconditional jump instruction. It is noted that this program 200 is highly contrived and simplified to allow for exposition of the control flow emulation technique implementations described herein.

FIG. 3 is a program listing illustrating an exemplary implementation, in simplified form, of pseudo code for the second GPU shader program that is generated by using the emulation process of FIG. 1 to emulate the control flow the first GPU shader program 200 shown in FIG. 2. As exemplified in FIG. 3, the second GPU shader program 300 is coded in a higher-level programming language that does not allow arbitrary jumps, but does support switch case statements. The emulation process shown in FIG. 1 will now be will now be applied to the first GPU shader program 200 shown in FIG. 2 in order to facilitate the understanding of how the second GPU shader program 300 is iteratively generated from the program 200. Action 100 of FIG. 1 results in the prefix 302 being inserted into the program 300. Action 102 of FIG. 1 then evaluates the “set r1, 0” instruction of the program 200 as follows. Since “set r1, 0” is the first instruction in the program 200, action 106 of FIG. 1 operates to insert the “case 0:” label into the program 300. Since “set r1, 0” is not a jump instruction, action 112 of FIG. 1 operates to translate “set r1, 0” into the statement “r1=0” in the program 300. Since “set r1, 0” is not the last instruction in the program 200, action 102 of FIG. 1 then evaluates the “set r2, 3” instruction of the program 200 as follows. Since “set r2, 3” is neither the first instruction, nor a jump destination, nor a jump instruction, action 112 of FIG. 1 operates to translate “set r2, 3” into the statement “r2=3” in the program 300. Since “set r2, 3” is not the last instruction in the program 200, action 102 of FIG. 1 then evaluates the “jmp L5” instruction of the program 200 as follows. Since “jmp L5” is neither the first instruction nor a jump destination, but “jmp L5” is an unconditional jump instruction, action 110 of FIG. 1 operates to translate “jmp L5” into the pair of statements 304 in the program 300. Since “jmp L5” is not the last instruction in the program 200, action 102 of FIG. 1 then evaluates the “L5: add r0, r1, r2” instruction of the program 200 as follows. Since “L5: add r0, r1, r2” is neither the first instruction nor a jump instruction, but “L5: add r0, r1, r2” is a jump destination, action 106 of FIG. 1 operates to insert the “case 5:” label into the program 300, and action 112 of FIG. 1 operates to translate “add r0, r1, r2” into the statement “r0=r1+r2” in the program 300. Since “L5: add r0, r1, r2” is the last instruction in the program 200, action 116 of FIG. 1 then results in the suffix 306 being inserted into the program 300.

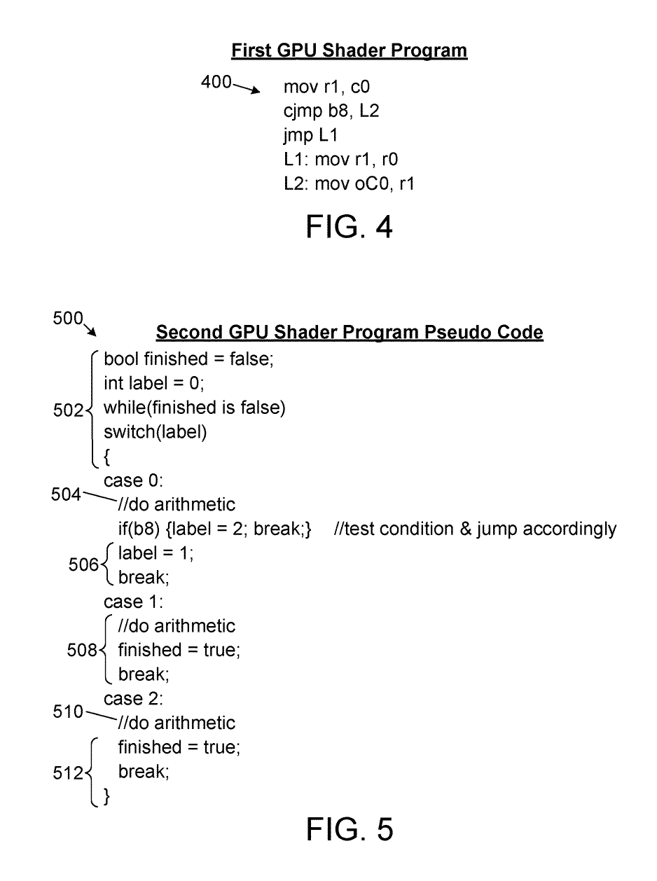

FIG. 4 is a program listing illustrating another implementation, in simplified form, of the first GPU shader program that includes both a conditional jump instruction and an unconditional jump instruction. As exemplified in FIG. 4, the first GPU shader program 400 includes a sequence of five instructions and is coded in a low-level programming language that allows arbitrary jumps. More particularly, one of the instructions in the program 400 (the “cjmp b8, L2” instruction) is a conditional jump instruction and another one of the instructions in the program 400 (the “jmp L1” instruction) is an unconditional jump instruction. It is noted that this program 400 is highly contrived and simplified to allow for exposition of the control flow emulation technique implementations described herein.

FIG. 5 is a program listing illustrating an exemplary implementation, in simplified form, of pseudo code for the second GPU shader program that is generated by using the emulation process of FIG. 1 to emulate the control flow the first GPU shader program 400 shown in FIG. 4. As exemplified in FIG. 5, the second GPU shader program 500 is coded in a higher-level programming language that does not allow arbitrary jumps, but does support switch case statements. The emulation process shown in FIG. 1 will now be will now be applied to the first GPU shader program 400 shown in FIG. 4 in order to facilitate the understanding of how the second GPU shader program 500 is iteratively generated from the program 400. Action 100 of FIG. 1 results in the prefix 502 being inserted into the program 500. Action 102 of FIG. 1 then evaluates the “mov r1, c0” instruction of the program 400 as follows. Since “mov r1, c0” is the first instruction in the program 400, action 106 of FIG. 1 operates to insert the “case 0” label into the program 500. Since “mov r1, c0” is not a jump instruction, action 112 of FIG. 1 operates to translate “mov r1, c0” into a statement 504 in the program 500 that is equivalent to “mov r1, c0”. Since “mov r1, c0” is not the last instruction in the program 400, action 102 of FIG. 1 then evaluates the “cjmp b8, L2” instruction of the program 400 as follows. Since “cjmp b8, L2” is neither the first instruction nor a jump destination, but “cjmp b8, L2” is a conditional jump instruction, action 110 of FIG. 1 operates to translate “cjmp b8, L2” into the statement “if(b8) {label=2; break;}” in the program 500. Since “cjmp b8, L2” is not the last instruction in the program 400, action 102 of FIG. 1 then evaluates the “jmp L1” instruction of the program 400 as follows. Since “jmp L1” is neither the first instruction nor a jump destination, but “jmp L1” is an unconditional jump instruction, action 110 of FIG. 1 operates to translate “jmp L1” into the pair of statements 506 in the program 500. Since “jmp L1” is not the last instruction in the program 400, action 102 of FIG. 1 then evaluates the “L1: mov r1, r0” instruction of the program 400 as follows. Since “L1: mov r1, r0” is neither the first instruction nor a jump instruction, but “L1: mov r1, r0” is a jump destination, action 106 of FIG. 1 operates to insert the “case 1:” label into the program 500, and action 112 of FIG. 1 operates to translate “mov r1, r0” into the triplet of statements 508 in the program 500. Since “L1: mov r1, r0” is not the last instruction in the program 400, action 102 of FIG. 1 then evaluates the “L2: mov oC0, r1” instruction of the program 400 as follows. Since “L2: mov oC0, r1” is neither the first instruction nor a jump instruction, but “L2: mov oC0, r1” is also a jump destination, action 106 of FIG. 1 operates to insert the “case 2:” label into the program 500, and action 112 of FIG. 1 operates to translate “mov oC0, r1” into a statement 510 in the program 500 that is equivalent to “mov oC0, r1”. Since “mov oC0, r1” is the last instruction in the program 400, action 116 of FIG. 1 then results in the suffix 512 being inserted into the program 500.

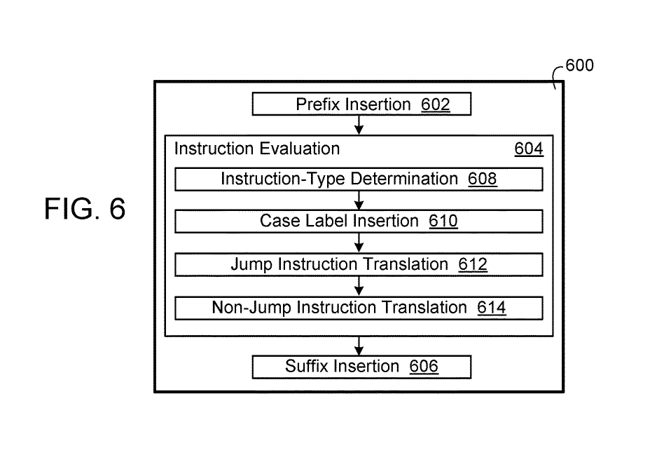

FIG. 6 illustrates an exemplary implementation, in simplified form, of a shader program translator computer program for emulating the control flow of a given first GPU shader program in a given second GPU shader program. As exemplified in FIG. 6 and referring again to FIG. 1, the shader program translator computer program 600 includes, but is not limited to, a prefix insertion sub-program 602 that performs action 100, an instruction evaluation sub-program 604 that performs action 102, and a suffix insertion sub-program 606 that performs action 116. The instruction evaluation sub-program 604 includes an instruction-type determination sub-program 608 that performs actions 104/108/114, a case label insertion sub-program 610 that performs action 106, a jump instruction translation sub-program 612 that performs action 110, and a non-jump instruction translation sub-program 614 that performs action 112. Each of the just-described sub-programs is realized on a computing device such as that which is described in more detail in the Exemplary Operating Environments section which follows.

Given the foregoing, it will be appreciated that the control flow emulation technique implementations described herein translate the entire sequence of instructions that makes up the first GPU shader program into a single switch case construction (e.g., a single state machine). It will also be appreciated that the control flow emulation technique implementations may be realized in a variety of ways. By way of example but not limitation, the control flow emulation technique implementations may be realized in the form of software in a control flow emulator application. The control flow emulation technique implementations may also be realized in the form of a driver shim that is used to enable older graphics processing hardware to work with newer graphics software applications (e.g., video game applications, among other types of graphics software applications), or to enable newer graphics processing hardware to work with older graphics software applications, or to enable graphics software applications to run outside of their originally intended operating environment (e.g., on a different computer operating system). Additionally, the control flow emulation technique implementations may be realized on a single computing device, or on a plurality of computing devices that are in communication with each other via a computer network.

### 2.0 Other Implementations

While the control flow emulation technique has been described by specific reference to implementations thereof, it is understood that variations and modifications thereof can be made without departing from the true spirit and scope of the control flow emulation technique. It is also noted that any or all of the aforementioned implementations throughout the description may be used in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 3.0 Exemplary Operating Environments

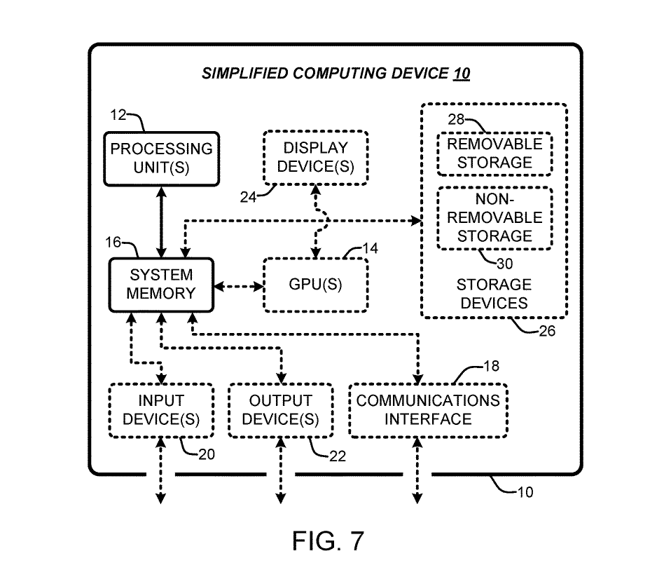

The control flow emulation technique implementations described herein are operational within numerous types of general purpose or special purpose computing system environments or configurations. FIG. 7 illustrates a simplified example of a general-purpose computer system on which various implementations and elements of the control flow emulation technique, as described herein, may be implemented. It is noted that any boxes that are represented by broken or dashed lines in the simplified computing device 10 shown in FIG. 7 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the control flow emulation technique implementations described herein, the device should have a sufficient computational capability and system memory to enable basic computational operations. In particular, the computational capability of the simplified computing device 10 shown in FIG. 7 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of the control flow emulation technique implementations described herein, including input, output, control, feedback, and response to one or more users or other devices or systems associated with the control flow emulation technique implementations, are enabled by a variety of Natural User Interface (NUI) scenarios. The NUI techniques and scenarios enabled by the control flow emulation technique implementations include, but are not limited to, interface technologies that allow one or more users user to interact with the control flow emulation technique implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors (e.g., speech and/or voice recognition). Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the control flow emulation technique implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the control flow emulation technique implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 7 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, programs, sub-programs, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, programs, sub-programs, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, sub-programs, and/or computer program products embodying some or all of the various control flow emulation technique implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The control flow emulation technique implementations described herein may be further described in the general context of computer-executable instructions, such as programs, sub-programs, being executed by a computing device. Generally, sub-programs include routines, programs, objects, components, data structures, and the like, that perform particular tasks or implement particular abstract data types. The control flow emulation technique implementations may also be practiced in distributed computing environments where tasks are performed by one or more remote processing devices, or within a cloud of one or more devices, that are linked through one or more communications networks. In a distributed computing environment, sub-programs may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

### 4.0 Claim Support and Further Implementations

The following paragraphs summarize various examples of implementations which may be claimed in the present document. However, it should be understood that the implementations summarized below are not intended to limit the subject matter which may be claimed in view of the foregoing descriptions. Further, any or all of the implementations summarized below may be claimed in any desired combination with some or all of the implementations described throughout the foregoing description and any implementations illustrated in one or more of the figures, and any other implementations described below. In addition, it should be noted that the following implementations are intended to be understood in view of the foregoing description and figures described throughout this document.

In one implementation a system is employed for emulating the control flow of a first graphics-processing-unit (GPU) shader program in a second GPU shader program, where the first GPU shader program includes a sequence of instructions and is coded in a low-level programming language that allows arbitrary jumps, and the second GPU shader program is coded in a higher-level programming language that does not allow arbitrary jumps. This system includes a shader program translator that includes one or more computing devices, where these computing devices are in communication with each other via a computer network whenever there is a plurality of computing devices. The shader program translator also includes a computer program having a plurality of sub-programs executable by the one or more computing devices, the one or more computing devices being directed by the sub-programs of the computer program to, individually evaluate each of the instructions in the sequence of instructions, where this evaluation includes sub-programs for, determining if the instruction is the first instruction in the first GPU shader program or a jump destination therein, whenever it is determined that the instruction is the first instruction in the first GPU shader program or a jump destination therein, inserting an appropriate case label into the second GPU shader program, determining if the instruction is a jump instruction, and whenever it is determined that the instruction is a jump instruction, translating the jump instruction into an appropriate switch case statement in the higher-level programming language, and inserting this switch case statement into the second GPU shader program.

In one implementation of the just-described system the sub-program for translating the jump instruction into an appropriate switch case statement in the higher-level programming language includes sub-programs for: whenever the jump instruction is an unconditional jump instruction, decoding the destination of the unconditional jump instruction, and setting a label based on this decoding. In another implementation the sub-program for translating the jump instruction into an appropriate switch case statement in the higher-level programming language includes sub-programs for: whenever the jump instruction is a conditional jump instruction that specifies a condition which has to be met in order for the jump to be executed, decoding the destination of the conditional jump instruction, decoding the condition, generating an appropriate statement in the higher-level programming language that evaluates the condition, and setting a label based on the outcome of evaluating the condition.

In another implementation the sub-program for individually evaluating each of the instructions in the sequence of instructions further includes sub-programs for, whenever it is determined that the instruction is not a jump instruction, translating the instruction into an appropriate statement in the higher-level programming language that is equivalent to the instruction, and inserting this appropriate statement into the second GPU shader program. In another implementation the low-level programming language includes a conventional shader assembly language. In another implementation the higher-level programming language includes a conventional High-Level Shader Language. In another implementation the higher-level programming language includes a conventional Open Graphics Library Shading Language. In another implementation the first GPU shader program includes one of: a pixel shader program; or a vertex shader program; or a geometry shader program; or a tessellation shader program.

In another implementation a computer-implemented process is employed for emulating the control flow of a first graphics-processing-unit (GPU) shader program in a second GPU shader program, where the first GPU shader program includes a sequence of instructions and is coded in a low-level programming language that allows arbitrary jumps, and the second GPU shader program is coded in a higher-level programming language that does not allow arbitrary jumps. This process includes the actions of: using one or more computing devices to perform the following process actions, where the computing devices are in communication with each other via a computer network whenever a plurality of computing devices is used: individually evaluating each of the instructions in the sequence of instructions, where this evaluation includes the actions of, determining if the instruction is the first instruction in the first GPU shader program or a jump destination therein, whenever it is determined that the instruction is the first instruction in the first GPU shader program or a jump destination therein, inserting an appropriate case label into the second GPU shader program, determining if the instruction is a jump instruction, and whenever it is determined that the instruction is a jump instruction, translating the jump instruction into an appropriate switch case statement in the higher-level programming language, and inserting this switch case statement into the second GPU shader program.

In one implementation of the just-described process the process action of translating the jump instruction into an appropriate switch case statement in the higher-level programming language includes the actions of: whenever the jump instruction is an unconditional jump instruction, decoding the destination of the unconditional jump instruction, and setting a label based on this decoding. In another implementation the process action of translating the jump instruction into an appropriate switch case statement in the higher-level programming language includes the actions of: whenever the jump instruction is a conditional jump instruction that specifies a condition which has to be met in order for the jump to be executed, decoding the destination of the conditional jump instruction, decoding the condition, generating an appropriate statement in the higher-level programming language that evaluates the condition, and setting a label based on the outcome of evaluating the condition. In another implementation the process action of individually evaluating each of the instructions in the sequence of instructions further includes the actions of, whenever it is determined that the instruction is not a jump instruction, translating the instruction into an appropriate statement in the higher-level programming language that is equivalent to the instruction, and inserting this appropriate statement into the second GPU shader program.

In another implementation the low-level programming language includes a conventional shader assembly language. In another implementation the higher-level programming language includes a conventional High-Level Shader Language. In another implementation the higher-level programming language includes a conventional Open Graphics Library Shading Language. In another implementation the first GPU shader program includes one of: a pixel shader program; or a vertex shader program; or a geometry shader program; or a tessellation shader program.

In another implementation a computer-readable storage medium is employed which has computer-executable instructions stored thereon that, responsive to execution by a computing device, cause the computing device to emulate the control flow of a first graphics-processing-unit (GPU) shader program in a second GPU shader program, where the first GPU shader program includes a sequence of instructions and is coded in a low-level programming language that allows arbitrary jumps, and the second GPU shader program is coded in a higher-level programming language that does not allow arbitrary jumps. This emulation includes: individually evaluating each of the instructions in the sequence of instructions, where this evaluation includes, determining if the instruction is the first instruction in the first GPU shader program or a jump destination therein, whenever it is determined that the instruction is the first instruction in the first GPU shader program or a jump destination therein, inserting an appropriate case label into the second GPU shader program, determining if the instruction is a jump instruction, and whenever it is determined that the instruction is a jump instruction, translating the jump instruction into an appropriate switch case statement in the higher-level programming language, and inserting this switch case statement into the second GPU shader program.

In one implementation of the just-described computer-readable storage medium translating the jump instruction into an appropriate switch case statement in the higher-level programming language includes: whenever the jump instruction is an unconditional jump instruction, decoding the destination of the unconditional jump instruction, and setting a label based on this decoding. In another implementation translating the jump instruction into an appropriate switch case statement in the higher-level programming language includes: whenever the jump instruction is a conditional jump instruction that specifies a condition which has to be met in order for the jump to be executed, decoding the destination of the conditional jump instruction, decoding the condition, generating an appropriate statement in the higher-level programming language that evaluates the condition, and setting a label based on the outcome of evaluating the condition. In another implementation individually evaluating each of the instructions in the sequence of instructions further includes, whenever it is determined that the instruction is not a jump instruction, translating the instruction into an appropriate statement in the higher-level programming language that is equivalent to the instruction, and inserting this appropriate statement into the second GPU shader program.

The implementations described in any of the previous paragraphs in this section may also be combined with each other, and with one or more of the implementations and versions described prior to this section.

Wherefore, what is claimed is:

1. A system for emulating the control flow of a first graphics-processing-unit (GPU) shader program in a second GPU shader program, the first GPU shader program comprising a sequence of instructions and being coded in a low-level programming language that allows arbitrary jumps, and the second GPU shader program being coded in a higher-level programming language that does not allow arbitrary jumps, the system comprising:
a shader program translator comprising one or more computing devices, said computing devices being in communication with each other via a computer network whenever there is a plurality of computing devices, and a computer program having a plurality of sub-programs executable by the one or more computing devices, the one or more computing devices being directed by the sub-programs of the computer program to,
individually evaluate each of the instructions in said sequence of instructions, said evaluation comprising sub-programs for,
determining if the instruction is the first instruction in the first GPU shader program or a jump destination therein,
whenever it is determined that the instruction is the first instruction in the first GPU shader program or a jump destination therein, inserting an appropriate case label into the second GPU shader program,
determining if the instruction is a jump instruction, and
whenever it is determined that the instruction is a jump instruction,
translating the jump instruction into an appropriate switch case statement in said higher-level programming language, and
inserting said switch case statement into the second GPU shader program.

2. The system of claim 1, wherein the sub-program for translating the jump instruction into an appropriate switch case statement in said higher-level programming language comprises sub-programs for:
whenever the jump instruction is an unconditional jump instruction,
decoding the destination of the unconditional jump instruction, and
setting a label based on said decoding.

3. The system of claim 1, wherein the sub-program for translating the jump instruction into an appropriate switch case statement in said higher-level programming language comprises sub-programs for:
whenever the jump instruction is a conditional jump instruction that specifies a condition which has to be met in order for the jump to be executed,
decoding the destination of the conditional jump instruction,
decoding said condition,
generating an appropriate statement in said higher-level programming language that evaluates said condition, and
setting a label based on the outcome of evaluating said condition.

4. The system of claim 1, wherein the sub-program for individually evaluating each of the instructions in said sequence of instructions further comprises sub-programs for, whenever it is determined that the instruction is not a jump instruction,
translating the instruction into an appropriate statement in said higher-level programming language that is equivalent to the instruction, and
inserting said appropriate statement into the second GPU shader program.

5. The system of claim 1, wherein said low-level programming language comprises a conventional shader assembly language.

6. The system of claim 1, wherein said higher-level programming language comprises a conventional High-Level Shader Language.

7. The system of claim 1, wherein said higher-level programming language comprises a conventional Open Graphics Library Shading Language.

8. The system of claim 1, wherein the first GPU shader program comprises one of:
a pixel shader program; or
a vertex shader program; or
a geometry shader program; or
a tessellation shader program.

9. A computer-implemented process for emulating the control flow of a first graphics-processing-unit (GPU) shader program in a second GPU shader program, the first GPU shader program comprising a sequence of instructions and being coded in a low-level programming language that allows arbitrary jumps, and the second GPU shader program being coded in a higher-level programming language that does not allow arbitrary jumps, the process comprising the actions of:
using one or more computing devices to perform the following process actions, the computing devices being in communication with each other via a computer network whenever a plurality of computing devices is used:
individually evaluating each of the instructions in said sequence of instructions, said evaluation comprising the actions of,
determining if the instruction is the first instruction in the first GPU shader program or a jump destination therein,
whenever it is determined that the instruction is the first instruction in the first GPU shader program or a jump destination therein, inserting an appropriate case label into the second GPU shader program,
determining if the instruction is a jump instruction, and
whenever it is determined that the instruction is a jump instruction,
translating the jump instruction into an appropriate switch case statement in said higher-level programming language, and
inserting said switch case statement into the second GPU shader program.

10. The process of claim 9, wherein the process action of translating the jump instruction into an appropriate switch case statement in said higher-level programming language comprises the actions of:
whenever the jump instruction is an unconditional jump instruction,
decoding the destination of the unconditional jump instruction, and
setting a label based on said decoding.

11. The process of claim 9, wherein the process action of translating the jump instruction into an appropriate switch case statement in said higher-level programming language comprises the actions of:
whenever the jump instruction is a conditional jump instruction that specifies a condition which has to be met in order for the jump to be executed,
decoding the destination of the conditional jump instruction,
decoding said condition,
generating an appropriate statement in said higher-level programming language that evaluates said condition, and
setting a label based on the outcome of evaluating said condition.

12. The process of claim 9, wherein the process action of individually evaluating each of the instructions in said sequence of instructions further comprises the actions of, whenever it is determined that the instruction is not a jump instruction,
translating the instruction into an appropriate statement in said higher-level programming language that is equivalent to the instruction, and
inserting said appropriate statement into the second GPU shader program.

13. The process of claim 9, wherein said low-level programming language comprises a conventional shader assembly language.

14. The process of claim 9, wherein said higher-level programming language comprises a conventional High-Level Shader Language.

15. The process of claim 9, wherein said higher-level programming language comprises a conventional Open Graphics Library Shading Language.

16. The process of claim 9, wherein the first GPU shader program comprises one of:
a pixel shader program; or
a vertex shader program; or
a geometry shader program; or
a tessellation shader program.

17. A computer-readable storage medium having computer-executable instructions stored thereon that, responsive to execution by a computing device, cause the computing device to emulate the control flow of a first graphics-processing-unit (GPU) shader program in a second GPU shader program, the first GPU shader program comprising a sequence of instructions and being coded in a low-level programming language that allows arbitrary jumps, and the second GPU shader program being coded in a higher-level programming language that does not allow arbitrary jumps, said emulation comprising:
individually evaluating each of the instructions in said sequence of instructions, said evaluation comprising,
determining if the instruction is the first instruction in the first GPU shader program or a jump destination therein,
whenever it is determined that the instruction is the first instruction in the first GPU shader program or a jump destination therein, inserting an appropriate case label into the second GPU shader program,
determining if the instruction is a jump instruction, and
whenever it is determined that the instruction is a jump instruction,
translating the jump instruction into an appropriate switch case statement in said higher-level programming language, and
inserting said switch case statement into the second GPU shader program.

18. The computer-readable storage medium of claim 17, wherein translating the jump instruction into an appropriate switch case statement in said higher-level programming language comprises:
whenever the jump instruction is an unconditional jump instruction,
decoding the destination of the unconditional jump instruction, and
setting a label based on said decoding.

19. The computer-readable storage medium of claim 17, wherein translating the jump instruction into an appropriate switch case statement in said higher-level programming language comprises:
whenever the jump instruction is a conditional jump instruction that specifies a condition which has to be met in order for the jump to be executed,
decoding the destination of the conditional jump instruction,
decoding said condition,
generating an appropriate statement in said higher-level programming language that evaluates said condition, and
setting a label based on the outcome of evaluating said condition.

20. The computer-readable storage medium of claim 17, wherein individually evaluating each of the instructions in said sequence of instructions further comprises, whenever it is determined that the instruction is not a jump instruction,
translating the instruction into an appropriate statement in said higher-level programming language that is equivalent to the instruction, and
inserting said appropriate statement into the second GPU shader program.
